(19) United States
(12) Patent Application Publication
(10) Pub. No.: US 2026/0159145 A1
(43) Pub. Date: Jun. 11, 2026

(54) Extended Cart

(71) Applicant: Zhejiang Hengfeng Top Leisure Co., Ltd., Zhejiang Province (CN)

(72) Inventor: Baoqing Yang, Wukang Town (CN)

(21) Appl. No.: 19/129,213

(22) PCT Filed: Nov. 17, 2023
(86) PCT No.: PCT/CN2023/132250

§ 371 Date: May 12, 2025

(30) Foreign Application Priority Data
Nov. 18, 2022 (CN) 202223076607.7

(51) Int. Cl. B62B 3/02

(52) U.S. Cl. CPC B62B 3/02; B62B 2205/06

(57) ABSTRACT

An extended cart has an unfolded state and a folded state. The cart has a plurality of outer vertical tubes, a plurality of side oblique beam assemblies, a plurality of end oblique beam assemblies, a bottom foldable bracket connected to all the outer vertical tubes, and a plurality of wheel assemblies provided at lower portions of corresponding outer vertical tubes. Each of the end oblique beam assemblies comprises at least one set of foldable rod assembly, and each of the side oblique beam assemblies comprises at least three sets of foldable rod assemblies. At each of the outer vertical tubes, one of the plurality of side oblique beam assemblies and one of the plurality of end oblique beam assemblies are connected to the corresponding outer vertical tube to form a frame for the cart.

### TECHNICAL FIELD

The present application belongs to the technical field of hand-pulled carts, and specifically relates to an extended cart.

### BACKGROUND ART

With the continuous improvement of living standards, modern people are facing increasing life and work pressures. There is a growing trend of individuals engaging in outdoor activities with family and friends on weekends to unwind, such as enjoying sunny day, barbecues and recreation. Folding carts make it convenient to transport outdoor gear and supplies, adding to enjoyment of outdoor living. Existing carts and luggage barrows typically have conventional dimensions, common length, and insufficient storage capacity when storing longer or more articles, failing to transport bulky items.

### SUMMARY

In order to solve the above technical problems, the present application aims at providing an extended cart, which is easy to unfold and store and has a large volume.

In order to achieve the above objectives of the present application, the present application adopts technical solutions as follows.

Provided is an extended cart, having an unfolded state and a folded state, including a plurality of outer vertical tubes, a plurality of side oblique beam assemblies, a plurality of front-rear oblique beam assemblies, a bottom foldable bracket connected to all the outer vertical tubes, and a plurality of wheel assemblies provided at lower portions of corresponding outer vertical tubes, where each of the front-rear oblique beam assemblies includes at least one set of foldable rod assembly, each of the side oblique beam assemblies includes at least three sets of foldable rod assemblies, and four outer vertical tubes are connected through two side oblique beam assemblies and two front-rear oblique beam assemblies to form a frame.

As a preferred solution, the bottom foldable bracket includes at least two sets of X-shaped hinged rod assemblies or two sets of Y-shaped hinged rod assemblies, where two sets of X-shaped hinged rod assemblies are hinged through bottom connecting members B, and two sets of Y-shaped hinged rod assemblies are hinged through a central connecting member.

As a preferred solution, each of the X-shaped hinged rod assemblies includes bottom tubes and a bottom connecting member A, where one end of each of the four bottom tubes is hinged with the bottom connecting member A, the other ends of two bottom tubes are respectively hinged with lower portions of two outer vertical tubes, and the other ends of the other two bottom tubes are respectively hinged with two bottom tubes in another set of X-shaped hinged rod assembly through the bottom connecting members B.

As a preferred solution, a flexible connecting member is provided between two bottom connecting members B, and the flexible connecting member is also provided between the bottom connecting members B and the side oblique beam assemblies.

As a preferred solution, the Y-shaped hinged rod assembly includes bottom tubes and a bottom connecting member A, where one ends of three bottom tubes are all hinged with the bottom connecting member A, the other ends of two bottom tubes are respectively hinged with lower portions of two outer vertical tubes, and the other end of the other bottom tube is hinged with the bottom tube in the Y-shaped hinged rod assembly through the central connecting member.

As a preferred solution, the bottom foldable bracket further includes bottom side tubes respectively hinged with each outer vertical tube; two bottom side tubes on the same side are connected through a three-way hinge member, and two three-way hinge members are further connected through a tubular member that is foldable or telescopic.

As a preferred solution, each set of foldable rod assembly includes two rod members pivotally connected to each other, two rod members between adjacent foldable rod assemblies are hinged with each other, an upper end of each rod member of each side oblique beam assembly at two ends is hinged with an upper portion of the outer vertical tube through a short tube, and a lower end is hinged with a lower portion of the outer vertical tube; alternatively, the lower end of each rod member of each side oblique beam assembly at two ends is hinged with the lower portion of the outer vertical tube through the short tube, and the upper end is hinged with the upper portion of the outer vertical tube.

As a preferred solution, each set of foldable rod assembly includes two rod members pivotally connected to each other, two rod members between adjacent foldable rod assemblies are hinged with each other, an upper end of each rod member of each side oblique beam assembly at two ends is hinged with an upper portion of the outer vertical tube, a lower end of each rod member of each side oblique beam assembly at two ends is hinged with the outer vertical tube through a lower corner connecting member, and the lower corner connecting member is slidably provided on the outer vertical tube.

As a preferred solution, each of the outer vertical tubes is further internally provided with an inner vertical tube, each set of foldable rod assembly includes two rod members pivotally connected to each other, two rod members between adjacent foldable rod assemblies are hinged with each other, an upper end of each rod member of each side oblique beam assembly at two ends is hinged with an upper portion of the outer vertical tube, a lower end of each rod member of the side oblique beam assembly at two ends is hinged with a lower portion of the inner vertical tube, and with extension or retraction of the foldable rod assembly, the outer vertical tube and the inner vertical tube also undergo corresponding extension or retraction.

As a preferred solution, a front pull tube that is telescopic or foldable is further provided between two adjacent outer vertical tubes in a width direction, and the front pull tube is provided with a pull rod.

Compared with the prior art, the present application has beneficial effects as follows.

The side oblique beam assemblies at two sides of the cart of the present application employ a triple-cross structure at two sides, and the front-rear oblique beam assemblies employ a single-cross structure, thus compared with the prior luggage carts, the cart of the present application achieves a significantly extended length and a significantly increased volume, with a small packaging volume, and also enables convenient, rapid, and easy unfolding and folding.

### BRIEF DESCRIPTION OF DRAWINGS

Drawings of the description constituting a part of the present application are used for providing further understanding of the present application. Exemplary embodiments of the present application and descriptions thereof are provided to explain the present application, but do not constitute limitation to the present application.

FIG. 1 is a structural schematic diagram of a cart of the present application in a fully unfolded state;

FIG. 2 is a structural schematic diagram of the cart of the present application in a folding process;

FIG. 3 is a structural schematic diagram of the cart of the present application in a fully folded state;

FIG. 4 is a first kind of side structural schematic diagram of the cart of the present application;

FIG. 5 is a second kind of side structural schematic diagram of the cart of the present application;

FIG. 6 is a third kind of side structural schematic diagram of the cart of the present application;

FIG. 7 is a first kind of bottom structural schematic diagram of the cart of the present application; and

FIG. 8 is a second kind of bottom structural schematic diagram of the cart of the present application.

### REFERENCE SIGNS

1. bottom connecting member A; 2. side oblique beam assembly; 3. front-rear oblique beam assembly; 4. upper corner connecting member; 5. lower corner connecting member; 6. flexible connecting member; 7. bottom connecting member B; 8. bottom tube; 9. front pull tube; 10. pull rod; 11. outer vertical tube; 12. inner vertical tube; 13. Y-shaped foldable bottom bracket; 14. central connecting member; 15. bottom side tube; 16. three-way hinge member; 17. central hinge member.

### DETAILED DESCRIPTION OF EMBODIMENTS

It should be noted that the following detailed descriptions are illustrative, aiming at further explaining the present application. Unless otherwise noted, all the technical and scientific terms used herein have the same meanings as commonly understood by those ordinarily skilled in the art to which the present application belongs.

It should be noted that the terms used herein are only for the purpose of describing the embodiments, but are not intended to limit exemplary embodiments in accordance with the present application. As used herein, the singular form is also intended to include the plural form as well, unless clearly indicated otherwise in the context. Besides, it also should be understood that when the terms “contain” and/or “comprise” are used in the present specification, they indicate the presence of a feature, a step, an operation, a part, a component and/or a combination thereof.

Besides, in the description of the present application, it should be understood that orientation or positional relationships indicated by the terms such as “center”, “longitudinal”, “transverse”, “length”, “width”, “thickness”, “up”, “down”, “front”, “rear”, “left”, “right”, “vertical”, “horizontal”, “top”, “bottom”, “inner”, “clockwise”, and “anticlockwise” are the orientation or positional relationships shown based on the drawings, only for facilitating the description of the present application and simplifying the description, rather than indicating or implying that the referenced devices or elements must be in a particular orientation, or constructed or operated in the particular orientation; therefore, they should not be construed as limitation to the present application.

In addition, the terms “first” and “second” are merely used for descriptive purposes but should not be construed as indicating or implying importance in the relativity or implicitly indicating the number of referenced technical features. Thus, defining a feature with “first” or “second” may explicitly or implicitly mean that one or more such features are included. In the description of the present application, unless otherwise specified, “a plurality of” means two or more, unless otherwise expressly defined.

In the present application, the terms such as “mount”, “couple”, “connect” and “fix” should be understood broadly unless otherwise expressly specified or defined. For example, a connection may be a fixed connection, a detachable connection or an integral connection, may be a mechanical connection or an electric connection, or may be direct coupling or indirect coupling via an intermediary, or internal communication between two elements. For those ordinarily skilled in the art, specific meanings of the above-mentioned terms in the present application could be understood according to specific circumstances.

In the present application, unless otherwise specified and defined explicitly, a first feature being “above” or “below” a second feature may include the first feature and the second feature being in direct contact, and also may include the first feature and the second feature being not in direct contact but being in contact through another feature therebetween. Moreover, the first feature being “on”, “above” or “over” the second feature includes the first feature being directly above or not directly above the second feature, or merely means the level of the first feature being higher than that of the second feature. The first feature “under”, “below” or “underneath” a second feature includes the first feature being directly below or not directly below the second feature, or merely means the level of the first feature being higher than that of the second feature.

The present application will be further described below in conjunction with the drawings and embodiments.

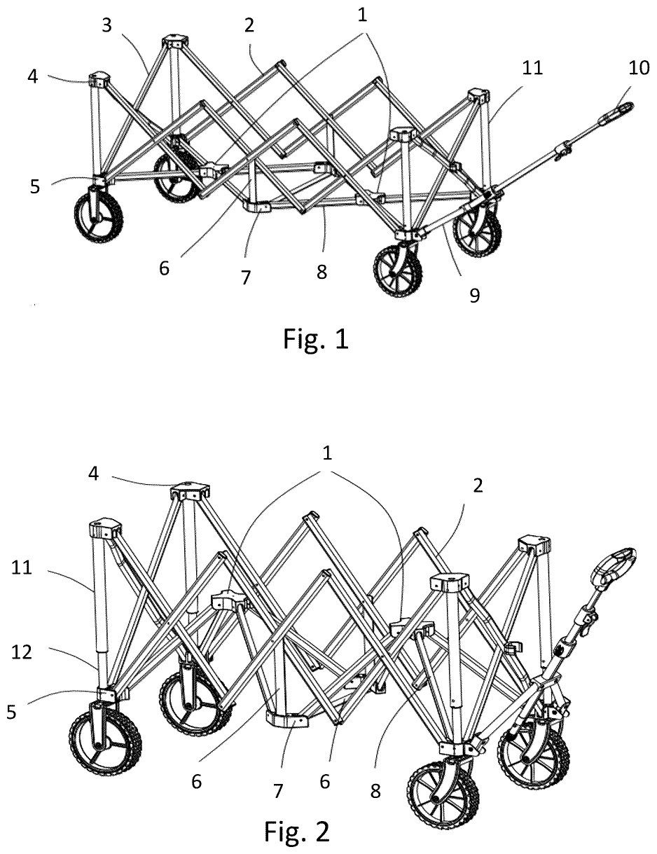

An extended cart as shown in FIG. 1 to FIG. 3, having an unfolded state and a folded state, includes a plurality of outer vertical tubes 11, a plurality of side oblique beam assemblies 2, a plurality of front-rear oblique beam assemblies 3, a bottom foldable bracket connected to all the outer vertical tubes 11, and a plurality of wheel assemblies 11 provided at lower portions of corresponding outer vertical tubes 11, where each front-rear oblique beam assembly 3 includes at least one set of foldable rod assembly, each side oblique beam assembly 2 includes at least three sets of foldable rod assemblies, and four outer vertical tubes 11 are connected through two side oblique beam assemblies 2 and two front-rear oblique beam assemblies 3 to form a frame.

The bottom foldable bracket includes at least two sets of X-shaped hinged rod assemblies. Two sets of X-shaped hinged rod assemblies are hinged through bottom connecting members B7. Each X-shaped hinged rod assembly includes bottom tubes 8 and a bottom connecting member A1, where one end of each of the four bottom tubes 8 is hinged with the bottom connecting member A1, the other ends of two bottom tubes 8 are respectively hinged with lower portions of two outer vertical tubes 11, and the other ends of the other two bottom tubes 8 are respectively hinged with two bottom tubes 8 in another set of X-shaped hinged rod assembly through the bottom connecting members B7. A flexible connecting member 6 is provided between the two bottom connecting members B7, and the flexible connecting member 6 is also provided between the bottom connecting members B7 and the side oblique beam assemblies 2. The flexible connecting members 6 are fixed on the side oblique beam assemblies 2, thus enhancing load-bearing capacity of a bottom bracket thereof.

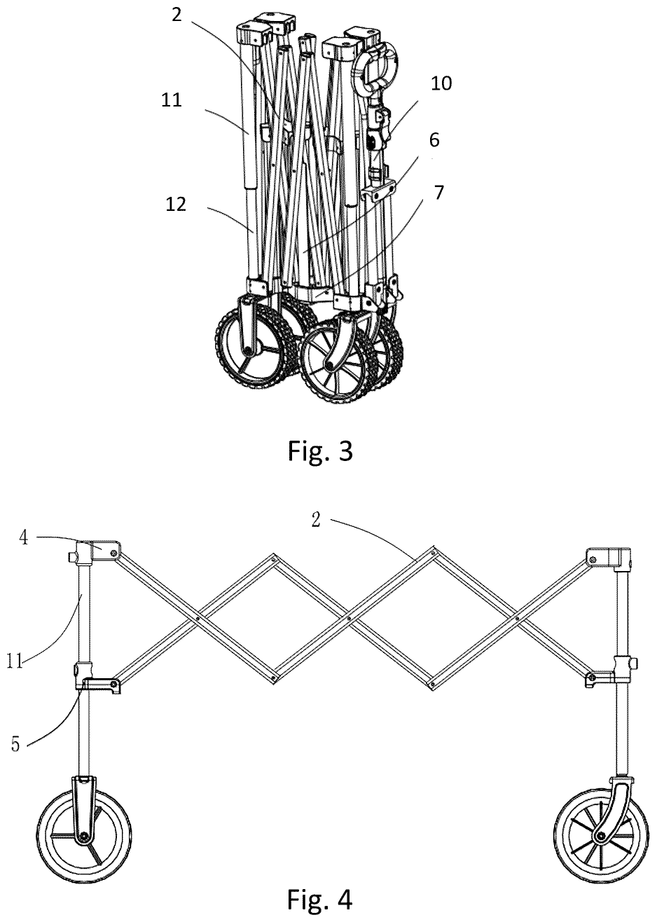

When folding the cart of the present application, the whole cart will be automatically folded as long as the bottom connecting members Al are lifted upwards (as shown in FIG. 2). The cart of the present application has advantages such as convenience, rapidness, and easiness in unfolding and folding, and is much longer than common carts, so that it can accommodate longer and more articles, with a small packaging volume after being folded, thus being convenient to carry (as shown in FIG. 3).

The side oblique beam assemblies 2 specifically have three types of structures as follows, but are not limited thereto.

I. Each outer vertical tube 11 is internally provided with an inner vertical tube 12, and a top portion of the outer vertical tube 11 is further fixed with an upper corner connecting member 4; a lower portion of the inner vertical tube 12 is fixed with a lower corner connecting member 5; each set of foldable rod assembly includes two rod members pivotally connected to each other, and two rod members between adjacent foldable rod assemblies are hinged with each other; an upper end of each rod member of each side oblique beam assembly 2 at two ends is hinged with an upper portion of the outer vertical tube 11 through the upper corner connecting member 4, a lower end of each rod member of each side oblique beam assembly 2 at two ends is hinged with a lower portion of the inner vertical tube 12 through the lower corner connecting member 5; and with extension or retraction of the foldable rod assembly, the outer vertical tube 11 and the inner vertical tube 12 also undergo corresponding extension or retraction (as shown in FIG. 4).

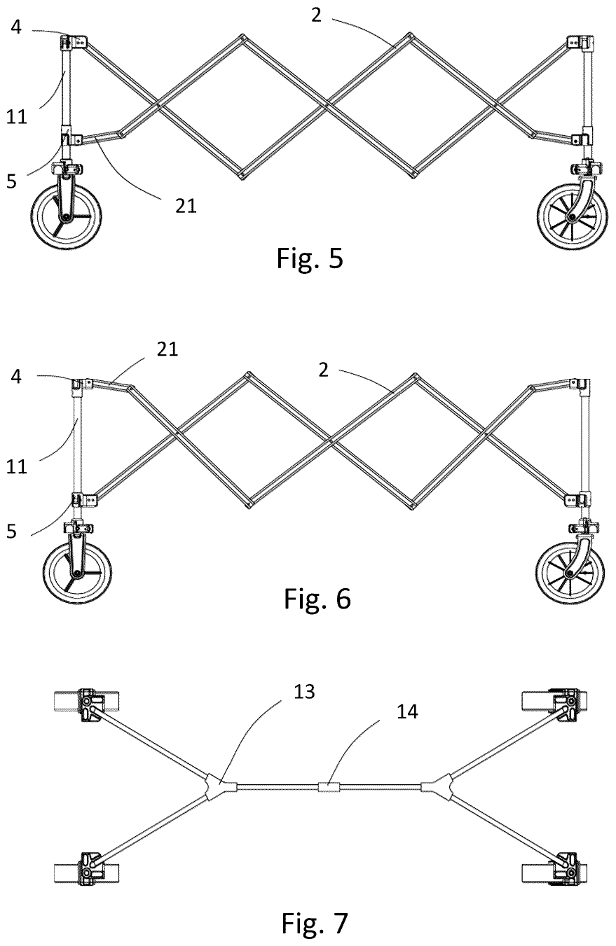

II. Each set of foldable rod assembly includes two rod members pivotally connected to each other, two rod members between adjacent foldable rod assemblies are hinged with each other, an upper end of each rod member of each side oblique beam assembly 2 at two ends is hinged with an upper portion of the outer vertical tube 11 through a short tube 21, and a lower end is hinged with a lower portion of the outer vertical tube 11. Alternatively, the lower end of each rod member of the side oblique beam assembly 2 at two ends is hinged with the connecting member 5 of the outer vertical tube 11 through the short tube 21, the connecting member 5 is fixed on the outer vertical tube 11, and the upper end is hinged with the upper portion of the outer vertical tube 11 (as shown in FIG. 5 and FIG. 6).

III. Each set of foldable rod assembly includes two rod members pivotally connected to each other, two rod members between adjacent foldable rod assemblies are hinged with each other, an upper end of each rod member of each side oblique beam assembly 2 at two ends is hinged with an upper portion of the outer vertical tube 11, a lower end of each rod member of the side oblique beam assembly 2 at two ends is hinged with the outer vertical tube 11 through the lower corner connecting member 5, and the lower corner connecting member 5 is slidably provided on the outer vertical tube 11.

As shown in FIG. 7, in other embodiments, the bottom foldable bracket can further include at least two sets of Y-shaped hinged rod assemblies, where two sets of Y-shaped hinged rod assemblies are hinged through a central connecting member 14. Each Y-shaped hinged rod assembly includes the bottom tubes 8 and the bottom connecting member Al, one end of each of the three bottom tubes 8 is hinged with the bottom connecting member Al, the other ends of two bottom tubes 8 are respectively hinged with lower portions of two outer vertical tubes 11, and the other end of the other bottom tube 8 is hinged with the bottom tube 8 in a Y-shaped hinged rod assembly through the central connecting member 14.

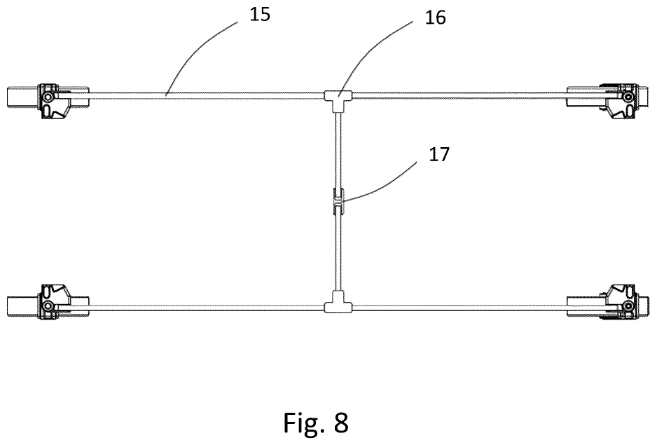

As shown in FIG. 8, in other embodiments, the bottom foldable bracket further may include bottom side tubes 15 respectively hinged with each outer vertical tube 11; two bottom side tubes 15 on the same side are connected through a three-way hinge member 16, and two three-way hinge members 16 are further connected through a tubular member that is foldable or telescopic. A central portion of the tubular member achieves folding through a central hinge member 17.

A telescopic or foldable front pull tube 9 is further provided between two adjacent outer vertical tubes 11 in a width direction of the cart of the present application, and the front pull tube 9 is provided with a pull rod 10.

The cart of the present application employs a triple-cross structure at two sides, and employs a single-cross structure at the front and rear, thus having an extended overall length to be capable of accommodating large and a large quantity of articles. The cart of the present application employs a dual-cross structure at the bottom, and uses a flexible connecting member for connection in the center, thereby enhancing the strength of the bottom bracket to prevent folding.

In the descriptions of the present specification, descriptions with reference to the terms such as “an embodiment”, “some embodiments”, “example”, “specific example”, or “some examples” mean that specific features, structures, materials or characteristics described in conjunction with this embodiment or example are comprised in at least one embodiment or example of the present disclose. In the present specification, exemplary expressions of the above terms do not necessarily refer to the same embodiment or example. Moreover, the described specific features, structures, materials or characteristics can be combined in an appropriate manner in any one or more embodiments or examples.

Although the embodiments of the present application have been shown and described in the above, it can be understood that the above embodiments are exemplary and shall not be construed as limitation to the present application. Those of ordinary skill in the art could make changes, amendments, substitutions and variations to the above embodiments within the scope of the present application without departing from the principle and purpose of the present application. Any simple amendments, equivalent changes and modifications made to the above embodiments based on the technical essence of the present application still fall within the scope of the technical solutions of the present application.

1. An extended cart, having an unfolded state and a folded state, the cart comprising a plurality of outer vertical tubes, a plurality of side oblique beam assemblies, a plurality of end oblique beam assemblies, a bottom foldable bracket connected to all the outer vertical tubes, and a plurality of wheel assemblies provided at lower portions of corresponding outer vertical tubes, wherein each of the end oblique beam assemblies comprises at least one foldable rod assembly, each of the side oblique beam assemblies comprises at least three foldable rod assemblies, and at each of the outer vertical tubes, one of the plurality of side oblique beam assemblies and one of the plurality of end oblique beam assemblies are connected to the corresponding outer vertical tube to form a frame for the cart.

2. The extended cart according to claim 1, wherein the bottom foldable bracket comprises at least two sets of X-shaped hinged rod assemblies, wherein the two sets of X-shaped hinged rod assemblies are hinged together through bottom connecting members.

3. The extended cart according to claim 2, wherein each of the X-shaped hinged rod assemblies comprises bottom tubes and a bottom hub connecting member, wherein one end of each of the bottom tubes is hinged with the bottom hub connecting member, the other ends of two bottom tubes are respectively hinged with lower portions of two outer vertical tubes, and the other ends of the other two bottom tubes are respectively operatively hinged with two bottom tubes of another set of X-shaped hinged rod assembly through the bottom connecting members.

4. The extended cart according to claim 3, wherein a flexible connecting member is provided between two bottom connecting members located on opposite sides of the cart between the side oblique beam assemblies.

5. The extended cart according to claim 1, wherein the Y-shaped hinged rod assembly comprises bottom tubes and a bottom hub connecting member, wherein one ends of three bottom tubes are all hinged with the bottom hub connecting member, the other ends of two bottom tubes are respectively hinged with lower portions of two outer vertical tubes, and the other end of the other bottom tube is hinged with the other bottom tube of another Y-shaped hinged rod assembly through the central connecting member.

6. The extended cart according to claim 1, wherein the bottom foldable bracket comprises bottom side tubes respectively hinged with each outer vertical tube; two bottom side tubes on one side of the cart are connected through a three-way hinge member on the one side of the cart, and two bottom side tubes on the other side of the cart are connected through another three-way hinge member on the other side of the cart, and two three-way hinge members are further connected together through a tubular member, the tubular member being one of foldable or telescopic.

7. The extended cart according to claim 1, wherein each foldable rod assembly of the side oblique beam assemblies comprises two rod members pivotally connected to each other, two rod members between adjacent foldable rod assemblies are hinged with each other, an upper end of each rod member of a foldable rod assembly at an end of the side oblique beam assembly is hinged with an upper portion of the outer vertical tube through a short tube, and a lower end of each rod member of a foldable rod assembly at an end of the side oblique beam assembly is hinged with a lower portion of the outer vertical tube (11).

8. The extended cart according to claim 1, wherein each foldable rod assembly of the side oblique beam assemblies comprises two rod members pivotally connected to each other, two rod members between adjacent foldable rod assemblies are hinged with each other, an upper end of each rod member of a foldable rod assembly at an end of the side oblique beam assembly is hinged with an upper portion of the outer vertical tube, a lower end of each rod member of a foldable rod assembly at an end of the side oblique beam assembly is hinged with the outer vertical tube through a lower corner connecting member, and the lower corner connecting member is slidably provided on the outer vertical tube.

9. The extended cart according to claim 1, wherein each of the outer vertical tubes is further provided with an inner vertical tube internal to the outer vertical tube, each of foldable rod assembly of the side oblique beam assemblies comprises two rod members pivotally connected to each other, two rod members between adjacent foldable rod assemblies are hinged with each other, an upper end of each rod member of a foldable rod assembly at an end of the side oblique beam assembly is hinged with an upper portion of the outer vertical tube, a lower end of each rod member of a foldable rod assembly at an end of the side oblique beam assembly is hinged with a lower portion of the inner vertical tube, and with extension or retraction of the foldable rod assembly, the outer vertical tube and the inner vertical tube also undergo corresponding extension or retraction.

10. The extended cart according to claim 1, further comprising a front pull tube, the front pull tube being one of telescopic or foldable, the front pull tube being provided of the frame between two adjacent outer vertical tubes in a width direction of the frame, and the front pull tube being provided with a pull rod extending from a distal end of the front pull tube.

11. The extended cart according to claim 1, wherein the bottom foldable bracket comprises at least two sets of Y-shaped hinged rod assemblies, wherein the two sets of Y-shaped hinged rod assemblies are hinged through a central connecting member.

12. The extended cart according to claim 1, wherein each foldable rod assembly of the side oblique beam assemblies comprises two rod members pivotally connected to each other, two rod members between adjacent foldable rod assemblies are hinged with each other, a lower end of each rod member of a foldable rod assembly at an end of the side oblique beam assembly is hinged with a lower portion of the outer vertical tube through a short tube, and an upper end of each rod member of a foldable rod assembly at an end of the side oblique beam assembly is hinged with an upper portion of the outer vertical tube.
